(19) United States
(12) Patent Application Publication
(10) Pub. No.: US 2009/0188161 A1
(43) Pub. Date: Jul. 30, 2009

(54) ROOF CONSTRUCTION FOR A GREENHOUSE

(75) Inventor: Jacobus Johannes Wilhelmus Van Dijk, Pijnacker (NL)

Correspondence Address: THE WEBB LAW FIRM, P.C., 700 KOPPERS BUILDING, 436 SEVENTH AVENUE, PITTSBURGH, PA, 15219, US

(73) Assignee: KLIMREK I.E. B.V., Pijnacker (NL)

(21) Appl. No.: 10/585,507

(22) PCT Filed: Jan. 10, 2005
(86) PCT No.: PCT/NL2005/000010

§ 371 Date: Jan. 14, 2008

(30) Foreign Application Priority Data
Jan. 9, 2004 (NL) 1025210

(51) Int. Cl. A01G 9/14; E04B 7/02

(52) U.S. Cl. 47/17; 52/90.1

(57) ABSTRACT

Roof construction for a greenhouse has two roof elements positioned at an angle, wherein first and second members extending between ridge and gutter are fitted in each roof element. The second members extend perpendicularly to the ridge/gutter and are members taking compressive load, while the first members joined thereto are members taking tensile load. There are tensioning members to introduce tension and pressure, respectively, into the construction. With this arrangement a particularly rigid whole is obtained. The tension members can be joined to ridge and gutter, but it is also possible to construct these with a shorter length.

The present invention relates to a roof construction for a greenhouse comprising a number of roof elements positioned at an angle, wherein each roof element extends between an upper boundary thereof and a gutter and comprises a translucent covering material, first and second members, wherein said second members extend essentially perpendicularly with respect to the gutter and are rigid under pressure and said first members extend obliquely with respect to said gutter and are joined at one end to said second members.

A roof construction of this type is disclosed in DE 2404954 A. In this construction the link between ridge and gutter of the roof construction shown in this publication is made up of a number of tubular sections. Some tubular sections (second members) extend perpendicularly between ridge and gutter, whilst other sections (first members) extend at an angle.

In the past greenhouses were produced by erecting a metal frame, in which glass was positioned at an angle. Triangular roof constructions were produced in this way, where the bases were supported by supports close to the corner points and there were gutters at the corner points.

For a number of applications it is important that the construction is as lightweight as possible. In greenhouses it is important that as much light as possible enters, as a result of which the size of a wide variety of sections has to be restricted as far as possible. After all, any increase in the amount of incident light immediately leads to an increase in the yield. Moreover, the sectional constructions used in the state of the art require regular maintenance and the way in which the sections and the panels, which are made either of glass or of plastic, are joined together is laborious.

The aim of the present invention is to provide a roof construction that has at least the same strength compared with existing roof constructions, that is to say has at least the same performance under comparable (weather) conditions, and which can be produced more easily and more lightweight.

A further aim of the present invention is to provide a roof construction with which it is possible to enlarge or increase the height of the working area.

Furthermore, the aim of the present invention is to be less dependent on the columns and supports on which such a roof construction bears.

This aim is realised with a roof construction as described above in that said first members are members taking tensile load, wherein there are at least two first and one second members in each roof element and the second member takes compressive load.

According to the present invention each roof construction comprises a self-supporting particularly rigid whole a result of the compressive/tensile forces acting therein.

According to one embodiment of the invention either the first members are provided with members producing tensile load and/or the second members are provided with members producing compressive load. In this way it is possible to introduce the desired tension into the plane of the roof after joining together the first and second members. However, it is also possible to introduce the compressive/tensile stress when joining together first and second members. According to a particular embodiment of the present invention, the roof assembly is made self-supporting. That is to say, this has such a rigidity that when at least two roof elements forming a roof construction are placed on a horizontal surface it does not tend to move outwards with the guttering sections. With this arrangement a longitudinal beam, such as gutter or ridge, can take compressive load in the longitudinal direction thereof. By making use of the members taking tensile load, such as tension members which preferably structurally cannot take compressive load, such as cables or rods, a tensile force is generated between the upper boundary and gutter concerned. This tensile force is taken up by the second members, the members taking compressive load. A particularly rigid whole is produced as a result. According to a particular embodiment, the second members, or members taking compressive load, can comprise the panels that are positioned in the roof surface concerned. In this case the panels will preferably be of double-walled construction in order to create adequate rigidity (to buckling). As a result of the use of the tension and compression members, particularly rigid sloping walls or roof elements of the roof construction are produced. As a result of the self-supporting nature, it is no longer necessary to support a guttering section by means of a series of columns. Furthermore, if a plastic material is used as screening, the weight of the roof construction can be appreciably restricted, which has a major effect on the further construction of the greenhouse. This applies in particular when using film material.

In a variant embodiment, where the junction between first members and second members is located between the top boundary and gutter, a tension member that runs essentially parallel to said ridge or gutter and is coupled to a subsequent junction of a further first and second member preferably extends from said junction.

According to the present invention a roof construction of particularly compact construction can be obtained by means of which the working height in the greenhouse can be optimised. Furthermore, large spans can be achieved, which further contributes to maximising the workspace.

According to the invention the tension members extend obliquely with respect to the guttering section. More particularly, these tension members extend obliquely in two directions, so that these preferably cross one another. The compression members can comprise any members known in the state of the art. It is also possible to use the covering material for this. That is to say, the screening is produced from a material that is rigid under pressure, such as two sheets located some distance apart that are joined to one another via some structure or other. Such sheets are made of plastic material that is translucent. Such panels consisting of plastic material have a relatively low weight compared with constructions with glass and can be rigid under pressure and rigid in respect of buckling both in the height direction and in the longitudinal direction. An example of materials to be used for such panels is polycarbonate or polymethyl methacrylate.

It is also possible to produce the members by making the bars rigid under pressure/resistant to tensile stress.

It is possible that the second member that takes up pressure is joined to the gutter construction and extends as far as the upper boundary of the covering material, for example to a ridge construction located there. However, it is also possible that the second member extends over a length shorter than the distance between the upper boundary of the covering material and the gutter.

The first member can extend from the uppermost point of such a second member and the covering material can be fixed thereto.

It is also possible that one or both of the members extend in a plane other than the plane of the covering material.

It is also possible to combine the compression/tension members with bars for supporting or accommodating the covering material. By this means the total surface area of the elements that impede the transmission of light can be reduced, as a result of which the crop yield can be increased.

According to a further advantageous embodiment the screening or the panel is made double-walled. A liquid for extracting energy or for cooling the greenhouse can optionally be introduced between the two walls, one wall of which can be flexible. For special features of such a construction reference is made to Netherlands patent application 1023900 in the name of Klimrek I. E. B. V.

So as to be able actively to fill and empty such a gap it is proposed to provide the guttering section with a channel that can be made to communicate with the gap between the two panels located some distance apart. Such a channel must be differentiated from internal and external gutters known in the prior art that can be present in such a guttering section. With such an embodiment the guttering section can be separated into two internal channels for the adjoining “left” panel section and the adjoining “right” panel section, which can be provided with different fluids. Supply of a liquid preferably takes place from an elevated point. If a ridge section is used as first longitudinal section, this can be provided with special means to enable such a supply. Each of the sections can be constructed as a rail section for transporting a wide variety of constructions used in the greenhouse along it. These constructions can be carriages for treatment operations, movable lighting and other generally known constructions. Moreover, the longitudinal beams in these constructions can be designed to accommodate screens that can be rolled up.

The invention will be explained in more detail below with reference to an illustrative embodiments shown in the drawing. In the drawing:

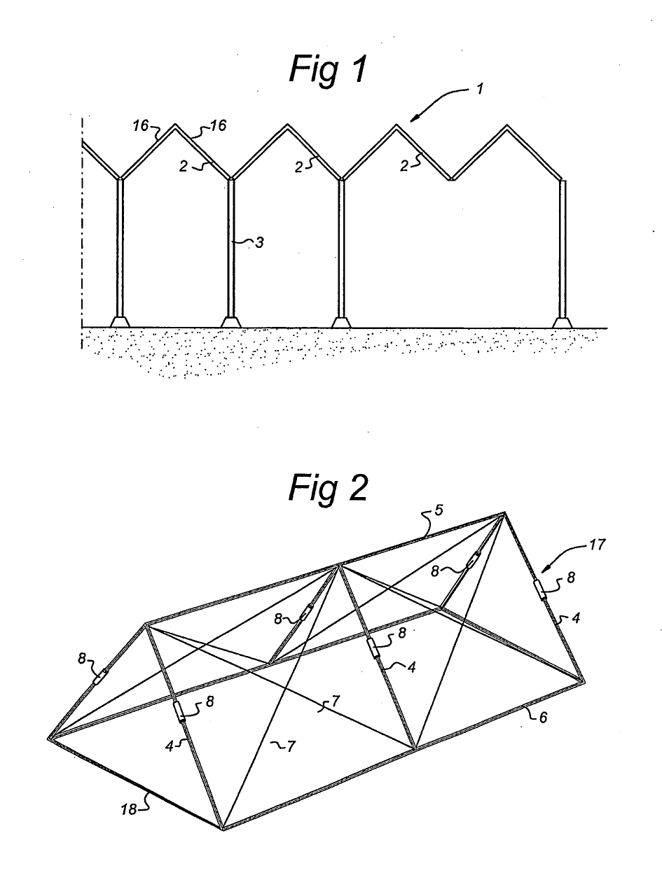

FIG. 1 shows, diagrammatically, a front view of a greenhouse provided with various roof constructions according to the invention;

FIG. 2 shows a detail of a roof construction;

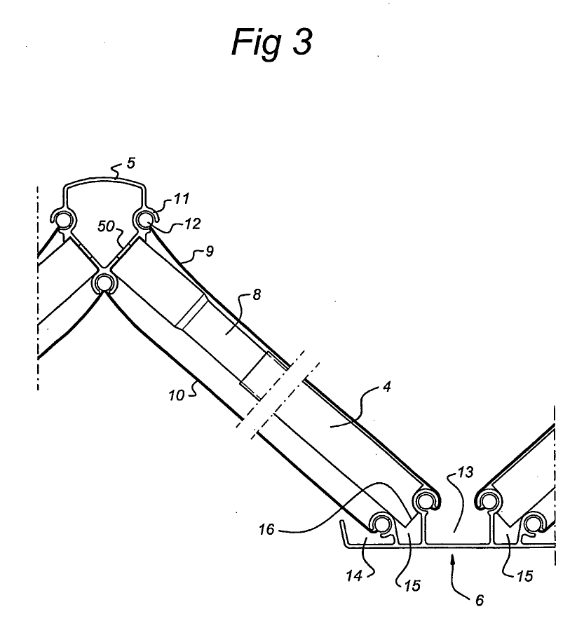

FIG. 3 shows, in detail, part of a ridge section and a guttering section;

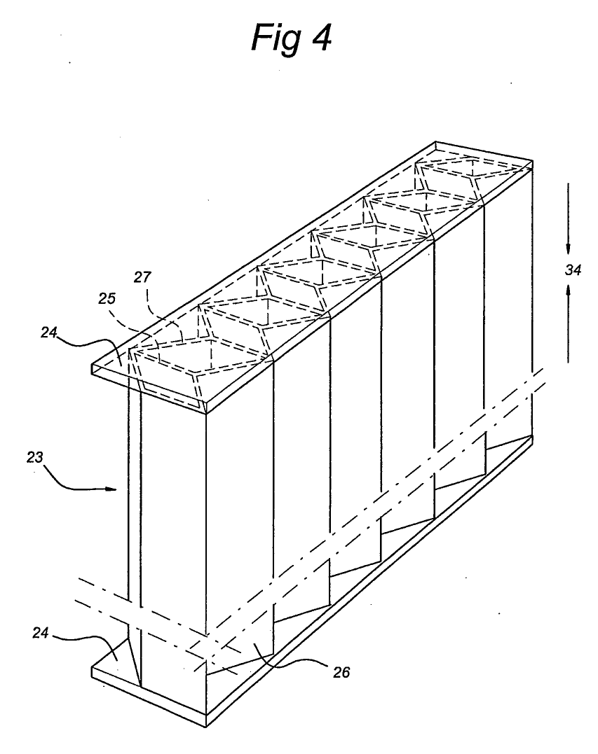

FIG. 4 shows a panel that is rigid under pressure, to be used in the invention;

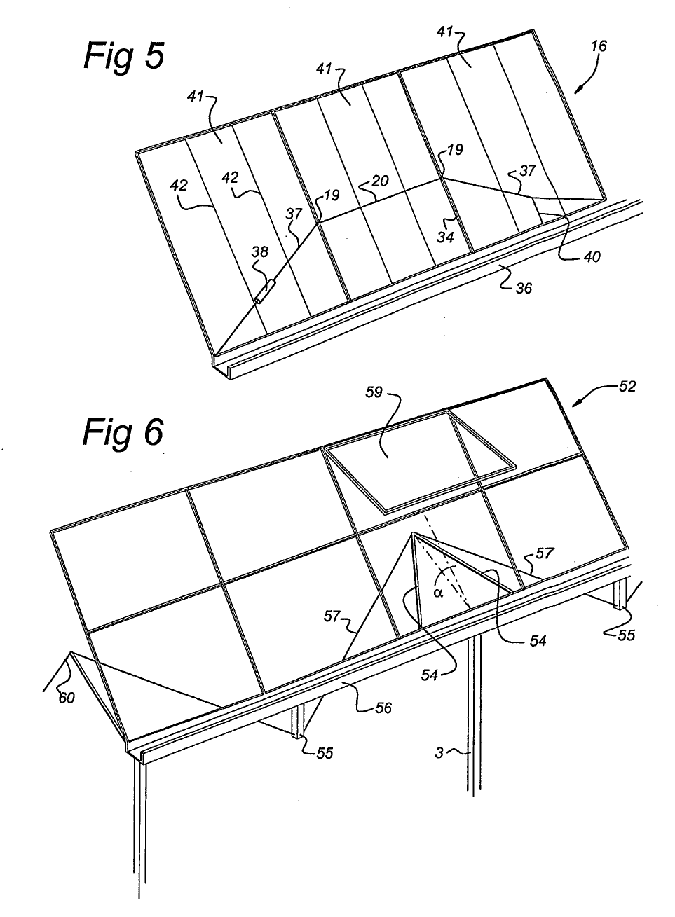

FIG. 5 shows, diagrammatically, a further embodiment of the roof construction;

FIG. 6 shows, diagrammatically, a further variant of the roof construction according to the invention and

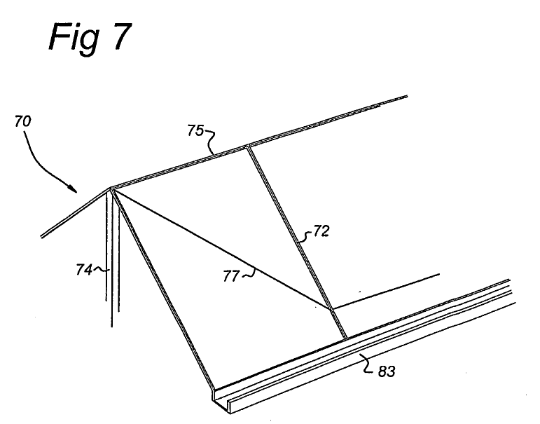

FIG. 7 shows a further embodiment of the roof construction according to the invention.

In FIG. 1 a greenhouse is indicated by 1. This consists of a number of vertical columns 3, on which a number of roof constructions 2 have been fitted. Roof constructions 2 according to the present invention are made self-supporting. As a result it is possible, as can be seen from the right-hand part of FIG. 1, to mount two adjacent roof constructions without the installation of a column 3 beneath them. In this example each roof construction 2 consists of two roof elements 16. Each roof element 16 consists of a translucent panel and a bar-like construction. The bar-like construction consists of first, or tension, members 7 and second members 4, or members 4 rigid under pressure. The bar construction is indicated in its entirety by 17. Details of this can be seen from FIG. 2. Cross-members 18 of adjacent roof elements optionally extend between the members 4. If, however, the join between the members 4 close to the ridge section 5 is rigid under moment, it is not necessary to use such cross-members 18, as a result of which greater freedom in the height direction in the greenhouse is obtained. It can be seen from FIG. 2 that guttering sections 6 are also present. The link between the guttering sections 6 and ridge sections 5 can be effected by means of the members 4 that are rigid under pressure.

The tension members 7, which are fitted such that they cross one another diagonally, extend between the members 4 rigid under pressure. These tension members can be cables, rods and the like. Tensioning members 8 can be incorporated in members 4 rigid under pressure. A particularly rigid construction is obtained by combination of tension members 7, elements 4 rigid under pressure and tension applied by tensioning members 8. The tensioning members 8 apply force to the members 4 rigid under pressure, as a result of which a pull on the tension members 7 is produced. Instead of the tensioning members 8 in the members 4 rigid under pressure, tensioning members for applying a tensile force, such as turnbuckles (not shown) can be fitted in the tension members 7, or a combination of the two is possible. In combination with the join rigid under moment between the members 4 rigid under pressure at the ridge section 5 and/or the cross-member 18 an independent, self-supporting roof construction is produced. The weight thereof can be kept low if the screening has a relatively low mass. That is to say, a plastic material is preferably used instead of glass. An example of this is given in FIG. 3. The outer screen consists of a film material 9 that is provided close to the ends thereof with strings 12 that are fitted in seats 11. Such strings can be made of PTFE material in order to promote the sliding characteristics thereof. There is a seat 11 in both the ridge section 5 and in the guttering section 6. It can also be seen from FIG. 3 that the roof construction according to the present invention is double-walled because of the presence of an inner screen 10. This can be fixed to the ridge section or guttering section, respectively, in some way or other known in the art. However, it is also possible to provide a fixing that corresponds to the fixing of the outer screen. In the embodiment according to FIG. 3 the tensioning member 8 can be above the tension member and designed to permanently apply a load (spring).

The guttering section is provided with three constructions acting as gutters. The outer gutter is indicated by 13 and the inner gutter (for condensate) by 14. 15 indicates a twin channel that via opening 16 is in communication with the space between the inner screen 10 and the outer screen 9. This space can optionally be filled with a liquid. Such filling preferably takes place from the top boundary, such as a longitudinal section that is provided with a corresponding feed 50. Via feed 50 the liquid can be poured or sprayed or atomised to the interior. In the latter case the top surface of the inner panel or the bottom surface of the outer panel can be moistened in a targeted manner.

The member rigid under pressure can have any desired profile in order to provide sufficient rigidity under pressure. Preferably this is of polygonal construction. Of course, there can be the customary facilities in the greenhouse, such as rails for transport, heating, lighting, screening, etc. In the absence of cross-member 18 it is possible to suspend constructions from the ridge section which can be moved without being impeded by such low cross-members. If the cross-member 18 is present, it is possible to perform activities within the triangle delimited by this. An alternative for, or supplement to, the members rigid under pressure is shown in FIG. 4. This comprises a panel 23, rigid under pressure, provided with end pieces 24. The panel rigid under pressure consists of a front sheet part and rear sheet part 26 and 27 joined by transverse ridges 25. Such a sheet can be a thermally insulating, translucent sheet. Various materials have been proposed for use in greenhouses. Such materials are mainly of interest because these have a relatively low weight and good insulation values, whilst reflection of light is restricted as far as possible. The characteristics can be even further improved by applying coatings. For a sheet shown in FIG. 1, with a panel height (length) of 2.60 m and a width of 1.20 m, a compressive strength of a few hundred kg in the direction of arrows 34 can be mentioned.

Such sheets are provided with end piece 24 at the ends thereof. These end pieces can be fitted thereto by gluing or in some other way. One example is an edging strip provided with plugs and acting as a water channel, the plugs being clamped between the sheet parts. Further fixings can be fitted to the end pieces 24. Such fixings provide linking to the further parts of the roof construction.

The material of the sheet parts 26, 27 can be isotropic. However, the sheet parts 6, 7 are preferably made of an anisotropic material. The compressive strength is preferably relatively high in one direction and preferably relatively low in one direction. With the construction according to the present invention the height direction will be the direction where there is high rigidity (under pressure) and the longitudinal direction the direction in which there is a lower rigidity. The latter is of importance in order to be able to absorb expansion, for example under the influence of changes in temperature, such as under the influence of solar radiation. In the longitudinal direction the sheet part as shown in FIG. 4 will behave as a relatively weak harmonica. Accurate fixation and increased rigidity is obtained by means of the tension members 7.

A roof element according to the present invention can be transported by road in the assembled state to its destination.

A further embodiment of the invention is shown in FIG. 5. In this figure the same reference numerals as in the previous figures have been used as far as possible. In this embodiment the tension members are indicated by 37. The location of the junction with the compression members 34 is not coincident with either the ridge or gutter but is located between them. This junction is indicated by 19. A further tension member 20 extends between two junctions. A tensioning member is indicated by 38. It is also possible to make links between the tension cables or tension rods 37 and the gutter 36. Such a link taking tensile load is indicated by 40. With this variant it is possible to accommodate the panels 41 between bars 42 and compression members 34, the construction being such that widthwise expansion is possible only at compression members 34. The compression members 34 can have a special construction for this purpose. In this way the bars 42 can be of less expensive construction and the width thereof can be restricted, which increases the light yield. Moreover, the bars 42 can bear on tension members, as a result of which this can be of lighter weight construction. The lines or the like, for example for moving a fluid that absorbs/releases energy from top to bottom, can optionally be fed through the compression members 34.

The construction shown in FIG. 6 consisting of members 57 taking tensile load and members 54 taking compressive load is fitted “inside” double glazing or other panel of the roof construction 52. The angle with the roof construction is indicated by α. As in the embodiment according to FIG. 5, the compression member 54 extends only over a limited portion of the height. As a result it is possible to obtain unimpeded access to a window 59 to be opened.

Compression members 54 are at a slight angle with respect to the gutter and thus replace a single column taking compressive load. Instead of two compression members 54 running as far as the gutter, it is also possible to use compression members running from a point in the gutter to the outside, a further tension member being stretched between the free ends thereof, such as 20 in FIG. 5. In the example shown here the tension members 57 extend via the gutter 56 beneath it and are joined to a short pressure column 55. The final (front) tension member is joined to the surroundings via a guy wire 60 to take up the lateral reaction force. Instead of, or in addition to, the short column 55 shown here it is possible to install a longitudinal beam extending below the gutter some distance away, on which beam the tension cables or tension rods engage. The tension rods or bars can, for example, be made of a simple type of steel, such as reinforcing iron. According to this construction it is possible to make long spans for the gutter and associated roof construction, as a result of which the number of columns in a greenhouse can be appreciably reduced.

Part of a double roof construction is shown in FIG. 7. This is indicated in its entirety by 70 and consists of a second member 74 that takes pressure and a tension member 77. A gutter is indicated by 83, whilst the ridge has reference numeral 75. An auxiliary bar 72 has been fitted. In the present case this auxiliary bar 72 is not rigid under pressure but takes tensile load.

In the present case the ridge 75 is shown as being straight, but it can also be arched. Therefore, this is also denoted by top boundary.

These and further variants are obvious to those skilled in the art after reading the above and fall within the scope of the present claims.

1-10. (canceled)

11. A roof construction for a greenhouse comprising a number of roof elements positioned at an angle, wherein each roof element extends between an upper boundary thereof and a gutter and comprises a translucent covering material, first and second members, wherein said second members extend essentially perpendicularly with respect to the gutter and are rigid under pressure and said first members extend obliquely with respect to said gutter and are joined at one end to said second members, wherein said first members are members taking tensile load, wherein there are at least two first and one second member in each roof element and the second member takes compressive load.

12. The roof construction according to claim 11, wherein said first members extend over said roof element only over part of the distance between top boundary and gutter.

13. The roof construction according to claim 12, wherein one end of the first members is joined some distance away from the top boundary or gutter, respectively, to the second members and a tension member extends from said junction essentially parallel to said ridge/gutter.

14. The roof construction according to claim 11, wherein said member extends above and below said gutter.

15. The roof construction according to claim 11, wherein said covering material comprises the member.

16. The roof construction according to claim 11, wherein said first members are fitted crossing one another.

17. The roof construction according to claim 15, wherein said covering material comprises a panel and wherein one of said panels is provided with a device emerging thereon for distributing a fluid over it.

18. The roof construction according to claim 11, wherein a window that hinges out of the plane of said panel is fitted in said element, the window operating device, when said window is in the closed position, comprising a mechanism located in said plane of said panel.

19. The roof construction according to claim 11, wherein the boundary of said covering material is fixed to said member.

20. A greenhouse having a number of roof constructions comprising a number of roof elements positioned at an angle, wherein each roof element extends between an upper boundary thereof and a gutter and comprises a translucent covering material, first and second members, wherein said second members extend essentially perpendicularly with respect to the gutter and are rigid under pressure and said first members extend obliquely with respect to said gutter and are joined at one end to said second members, wherein said first members are members taking tensile load, wherein there are at least two first and one second member in each roof element and the second member takes compressive load, wherein one of said members is common to two roof constructions.
